(19) United States
(12) Patent Application Publication
(10) Pub. No.: US 2016/0352814 A1
(43) Pub. Date: Dec. 1, 2016

(54) METHOD AND SYSTEM FOR TEMPLATE BASED CONTENT PROJECTION

(71) Applicant: Brillio LLC, Jersey City, NJ (US)

(72) Inventors: Karthik Gopalakrishnan Vinmani, Bangalore (IN); Renji K. Thomas, Bangalore (IN); Venkat Kumar Sivaramamurthy, Bangalore (IN)

(21) Appl. No.: 14/836,321

(22) Filed: Aug. 26, 2015

(30) Foreign Application Priority Data
May 28, 2015 (IN) 2691/CHE/2015

(51) Int. Cl. H04L 29/08; H04L 29/06

(52) U.S. Cl. CPC H04L 67/10; H04L 67/42

(57) ABSTRACT

Embodiments herein provide a method for template based content projection. The method includes displaying, on a primary electronic device, a plurality of templates corresponding to a secondary electronic device, wherein each template comprises at least one element, of the content, dynamically determined based on at least one parameter. The method includes selecting, on the primary electronic device, a template from the plurality of templates to project at least one element of the content corresponding to the template on the secondary electronic device.

### TECHNICAL FIELD

This application claims the benefit of India Complete Application No. 2691/CHE/2015, filed on May 28, 2015. The embodiments disclosed herein relates to projection systems and more particularly to a method and system for template based Peer-to-Peer content projection.

### BACKGROUND OF INVENTION

With the widespread adoption of Internet, information is presented on various electronic devices in the form of dynamic web pages. The ability to use the Internet to communicate the information is generally viewed as a cost effective approach. Additionally, flexibility of posting the information at a website and making it available in real time through web pages is also considered highly desirable.

The present technology exists to adapt a web page or content, when a request originates from a primary electronic device. On receiving the request at a server, the server dynamically renders the web page onto the primary electronic device by adjusting the content of the web page as per capability and context of the primary electronic device. In this scenario, in order to display the content of the webpage on the primary electronic device, the server processes the content to be presented and sends it to the primary electronic device. Further, the content is adapted on the primary electronic device based on the capability and the context of the primary electronic device.

Generally, a user may desire to project the content of the primary electronic device onto secondary electronic devices (such as a television, a display unit, or the like) through a wired or wireless medium. In the conventional system and method, the content of the primary device is presented in the same format on the secondary electronic device. For example, if the primary electronic device displays content-X then the same content-X, with no alterations, is projected on the secondary electronic device which results into a poor user experience.

Further, different systems and methods for navigating between the web pages on various electronic devices are proposed. In certain scenarios, a next page preview can be viewed on a primary electronic device. However, the format of the content rendered on the primary electronic device is not modified for projecting the content onto the secondary electronic device. Thus, the existing systems and methods are incapable for effectively adapting the content or modifying the format of the content, more specifically, while projecting the content of the primary electronic device onto the secondary electronic device.

The above information is presented as background information only to help the reader to understand the present invention. Applicants have made no determination and make no assertion as to whether any of the above might be applicable as Prior Art with regard to the present application.

### SUMMARY

Accordingly the embodiments herein provide a method for template based content projection. The method includes displaying, on a primary electronic device, a plurality of templates corresponding to a secondary electronic device, wherein each template comprises at least one element, of the content, dynamically determined based on at least one parameter. The method includes selecting, on the primary electronic device, a template from the plurality of templates to project at least one element of the content corresponding to the template on the secondary electronic device.

Accordingly the embodiments herein provide a primary electronic device for template based content projection. The primary electronic device comprises a controller module. The controller module can be configured to display a plurality of templates corresponding to a secondary electronic device, wherein each template comprises at least one element, of the content, dynamically determined based on at least one parameter. The controller module is further configured to select a template from the plurality of templates to project at least one element of the content corresponding to the template on the secondary electronic device.

Accordingly the embodiments herein provide a method for template based content projection. The method includes receiving, by a primary electronic device, the content from a server. The method includes displaying, on the primary electronic device, a plurality of templates corresponding to a secondary electronic device, wherein each template comprises at least one element, of the content, dynamically determined based on at least one parameter. The method includes selecting, on the primary electronic device, a template from the plurality of templates to project at least one element of the content corresponding to the template on the secondary electronic device.

Accordingly the embodiments herein provide a primary electronic device for template based content projection. The primary electronic device comprises a controller module. The controller module can be configured to receive the content from a server. The controller module can be configured to display a plurality of templates corresponding to a secondary electronic device, wherein each template comprises at least one element, of the content, dynamically determined based on at least one parameter. The controller module is further configured to select a template from the plurality of templates to project at least one element of the content corresponding to the template on the secondary electronic device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications can be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates a high level overview of a system comprising a server communicating with a primary electronic device configured for template based content projection on a secondary electronic device, in accordance with the embodiments described herein;

FIG. 2 illustrates a block diagram of the primary electronic device configured for template based content projection, in accordance with the embodiments described herein;

FIG. 3a illustrates a block diagram of a controller module configured for template based content projection on the secondary electronic device, in accordance with the embodiments described herein;

FIG. 3b illustrates a block diagram of a content creation and packaging system, in accordance with the embodiments described herein;

FIG. 4 is a flow diagram illustrating a method for template based content projection, in accordance with the embodiments described herein;

FIG. 5 is a flow diagram illustrating another method for template based content projection, in accordance with the embodiments described herein;

FIGS. 6a-6c illustrate example contents of a movie ticket booking page displayed on the primary electronic device, in accordance with the embodiments described herein;

FIGS. 7a-7d illustrate example contents of a product purchase webpage displayed on the primary electronic device, in accordance with the embodiments described herein; and

FIG. 8 illustrates a computing environment implementing the method for template based content projection, in accordance with the embodiments described herein.

### DETAILED DESCRIPTION OF INVENTION

The embodiments herein and the various features and details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate understanding of ways in which the embodiments herein can be practiced and to further enable those skilled in the art to practice the embodiments herein. Accordingly, the examples should not be construed as limiting the scope of the embodiments herein.

The embodiments herein provide a method and system for template based content projection. The method includes displaying, on a primary electronic device, a plurality of templates corresponding to a secondary electronic device. The primary electronic device is connected to the secondary electronic device. The primary electronic device may be connected to the secondary electronic device through a wired connection or a wireless connection. The wireless connection may be a Wireless Fidelity (Wi-Fi) connection, a Bluetooth Low Energy (BLE) connection, or the like.

Each template from the plurality of templates comprises at least one element, of the content. The plurality of templates are dynamically determined based on one or more parameters. The one or more parameters are associated with the secondary electronic device. The one or more parameters comprises capability parameters of the secondary electronic device, user context, nature of content, time of a day, a day of a month, a month of a year, an intent of a user, primary electronic device context, and secondary electronic device context. The capability parameters of the secondary electronic device may comprise processing power, display real-estate, or the like. Further, the method includes selecting, on the primary electronic device, a template from the plurality of templates to project at least one element of the content corresponding to the template on the secondary electronic device.

Furthermore, the method includes projecting at least one element of the content on the secondary electronic device. The element of the content is dynamically displayed on the secondary electronic device in accordance with the selected template.

The proposed system and method are simple and robust for effectively projecting contextualized content on the secondary electronic device even under scenarios where the secondary electronic device is a dumb terminal. Unlike the existing method and system, the proposed system and method is used to dynamically adapt the content onto the secondary electronic device thereby improving overall user experience. The one or more templates, used for projecting the content on the secondary electronic device are dynamically determined based on secondary electronic device features such as processing power, display resolution, display size, or the like. Thus, the content displayed on the primary electronic device is projected on the secondary electronic device based on the capability parameters of the secondary electronic device thereby adapting the content to be projected. Further, the proposed system and method can be implemented using existing infrastructure and may not require extensive setup and instrumentations.

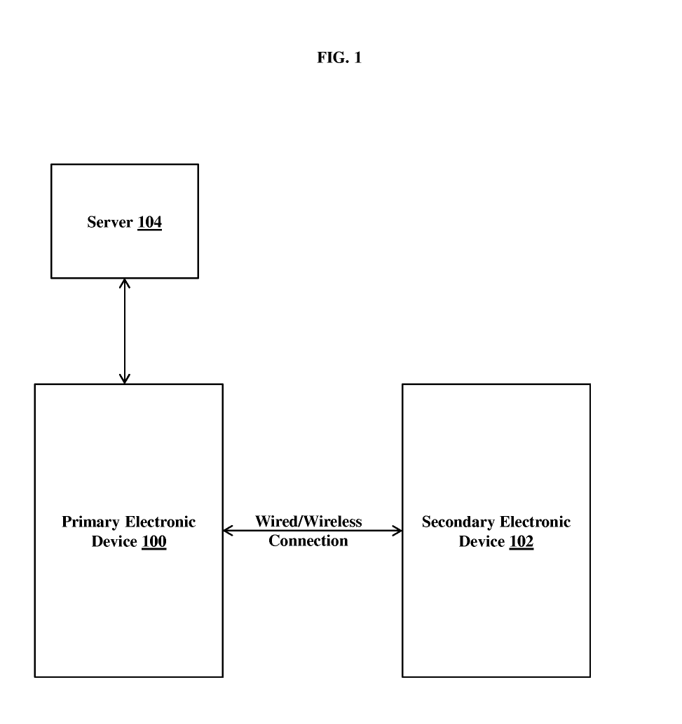

Referring now to the drawings and more particularly to FIGS. 1 to 8 where similar reference characters denote corresponding features consistently throughout the figures, there are shown preferred embodiments.

FIG. 1 illustrates a high level overview of a system comprising a server communicating with a primary electronic device configured for template based content projection on a secondary electronic device, in accordance with the embodiments described herein. The system comprises a primary electronic device 100 in communication with a secondary electronic device 102 and a server 104. In an embodiment, the primary electronic device 100 may be connected to the secondary electronic device 102 through a wired connection or a wireless connection. The wireless connection may be a Wireless Fidelity (Wi-Fi) connection, a Bluetooth Low Energy (BLE) connection, or the like.

In an embodiment, the primary electronic device 100 described herein may be for example, a cellular phone, a smart phone, a mobile phone, a wireless organizer, a personal digital assistant, a tablet, a handheld communication device, or the like.

In an embodiment, the secondary electronic device 102 described herein may be for example, a cellular phone, a smart phone, a wireless organizer, a personal digital assistant, a tablet, a handheld communication device, or the like. In an embodiment, the secondary electronic device 102 described herein may be a dumb terminal such as a legacy device, a display, a monitor, a television, or the like. Unlike conventional systems and methods, the proposed system and method can be used to contextualize the content to be presented on the secondary electronic device 102 even under scenarios where the secondary electronic device 102 is a dumb terminal.

In one embodiment, the primary electronic device 100 can be configured to receive content from the server 104. In another embodiment, the content may be already stored on the primary electronic device 100. In one embodiment, the server 104 may be a web server, a dynamic web server, or an embedded web server.

Further, the primary electronic device 100 can be configured to display a plurality of templates corresponding to the secondary electronic device 102. Each template from the plurality of templates comprises at least one element, of the content. Unlike conventional systems and methods, the plurality of templates described herein are dynamically determined based on one or more parameters such as for example, but is not limited to, capability parameters of the secondary electronic device 102, user context, nature of content, time of a day, a day of a month, a month of a year, an intent of a user, primary electronic device context, or secondary electronic device context. The capability parameters of the secondary electronic device 102 may include processing power, display real-estate, or the like.

Further, a user selects the template from the plurality of templates to project at least one element of the content corresponding to the template on the secondary electronic device 102. After selecting the template, the secondary electronic device 102 can be configured to display the element of the content dynamically in accordance with the selected template. Thus, the content projected on the secondary electronic device 102 is adapted based on the capability parameters of secondary electronic device 102, user context, or the like.

The FIG. 1 illustrates a limited overview of the system but, it is to be understood that other embodiments are not limited thereto. The labels provided to each module or component is only for illustrative purpose and does not limit the scope of the invention. Further, the one or more components can be combined or separated to perform the similar or substantially similar functionalities without departing from the scope of the invention. Furthermore, the system may include various other modules or components interacting locally or remotely along with other hardware or software components to communicate with each other for projecting the content on the secondary electronic device 102 based on the template selected by the user.

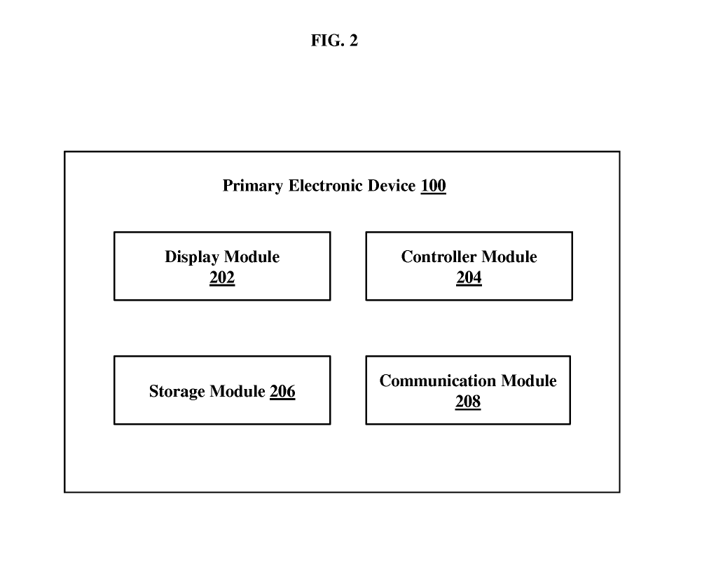

FIG. 2 illustrates a block diagram of the primary electronic device 100 configured for template based content projection, in accordance with the embodiments described herein.

In an embodiment, the primary electronic device 100 includes a display module 202, a controller module 204, a storage module 206, and a communication module 208.

The display module 202 can be configured to display the content on a user interface of the primary electronic device 100. In an embodiment, the content may be received from the server 104. For example, the content may be a webpage requested from the web server by the primary electronic device 100.

In another embodiment, the content may be already present or stored on the primary electronic device 100. For example, the content may be a word document, a power point presentation document, or a Portable Document Format (PDF) document received or created by the user.

The controller module 204 can be configured to determine a plurality of templates corresponding to the secondary electronic device 102. Each template comprises at least one element, of the content, dynamically determined based on one or more parameters. The one or more parameters comprises capability parameters of the secondary electronic device 102, user context, nature of content, time of a day, a day of a month, a month of a year, an intent of a user, primary electronic device context, and secondary electronic device context. The capability parameters of the secondary electronic device 102 may comprise processing power, display real-estate, or the like.

Further, the user may select the template from the plurality of templates to project at least one element of the content corresponding to the template on the secondary electronic device 102. After selecting the template, the secondary electronic device 102 can be configured to display at least one element of the content in accordance with the selected template.

In another embodiment, the controller module 204 can be configured to receive the content from the server 104. Further, the controller module 204 can be configured to display on the primary electronic device 100, the plurality of templates corresponding to the secondary electronic device 102. Each template comprises at least one element, of the content, dynamically determined based on the one or more parameters.

Further, the user may select the template from the plurality of templates to project at least one element of the content corresponding to the template on the secondary electronic device 102. Further, the controller module 204 can be configured to project at least one element of the content on the secondary electronic device 102. The element of the content is dynamically displayed on the secondary electronic device 102 in accordance with the selected template.

The storage module 206 may encompass one or more memory devices such as a read-only memory, a random access memory, a static random access memory, a dynamic random access memory, or the like. The storage module 206 can be configured to store data. The controller module 204 can be configured to retrieve the data from the storage module 206. The data stored in the storage module 206 may include operating systems, applications, and informational data. Each operating system includes executable code that controls basic functions of the primary electronic device 100. In addition, the storage module 206 may, in some examples, be considered a non-transitory storage medium. The term “non-transitory” may indicate that the storage medium is not embodied in a carrier wave or a propagated signal. However, the term “non-transitory” should not be interpreted to mean that the storage module 206 is non-movable. In some examples, the storage module 206 may be configured to store larger amounts of information than the memory. In certain examples, a non-transitory storage medium may store data that can, over time, change (e.g., in Random Access Memory (RAM) or cache).

The communication module 208 can be configured to transfer set of instructions internally between various modules in the primary electronic device 100. Further, the communication module 208 includes sufficient interfaces and channels to allow various components internally or remotely in the system for projecting the content based on the template selected by the user.

Unlike the existing systems, the primary electronic device 100 enables adaptation of the content on a projected device, i.e. the secondary electronic device 102. The primary electronic device 100 dynamically determines the one or more templates for projecting the content on the secondary electronic device 102. Also, the primary electronic device 100 allows the user to select the one or more templates for projecting the content. The primary electronic device 100 determines the one or more templates for content projection based on features of the device on which the content is projected such as processing power, display resolution, display size, or the like. Thus, the content displayed on the primary electronic device 100 is projected on the secondary electronic device 102 based on parameters of the secondary electronic device 102, thereby adapting the content to be projected.

The FIG. 2 illustrates a limited overview of the primary electronic device 100 but, it is to be understood that other embodiments are not limited thereto. The labels provided to each module or component is only for illustrative purpose and does not limit the scope of the invention. Further, the one or more modules can be combined or separated to perform the similar or substantially similar functionalities without departing from the scope of the invention. Furthermore, the primary electronic device 100 may include various other modules or components interacting locally or remotely along with other hardware or software components to communicate with each other for projecting the content on the secondary electronic device 102 based on the template selected by the user.

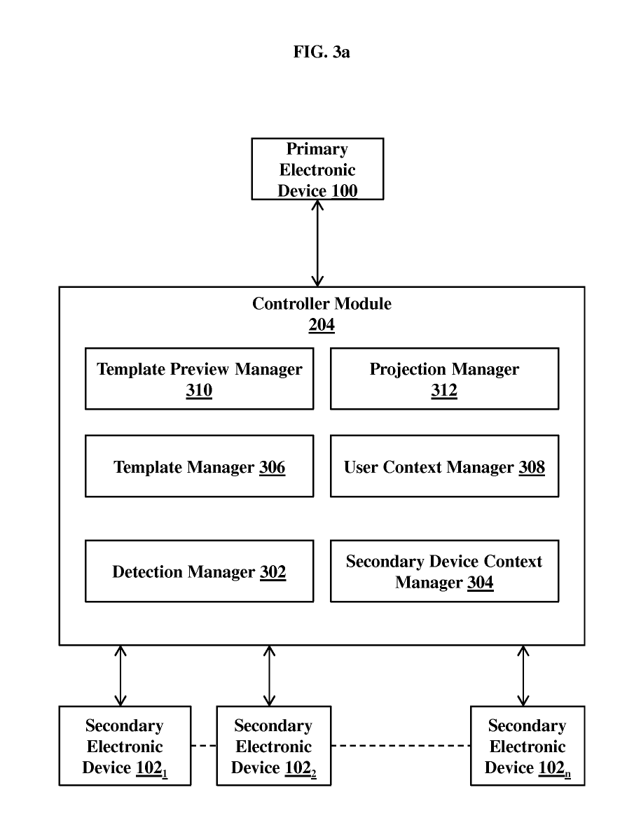

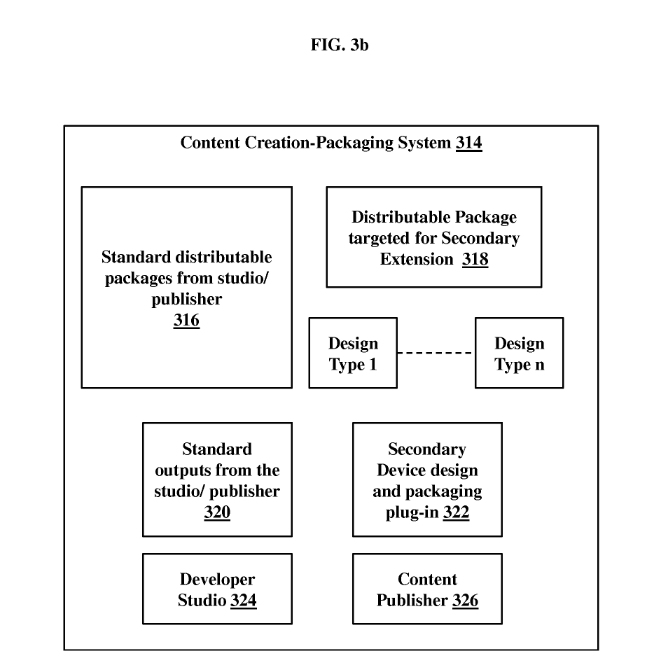

FIG. 3a illustrates a block diagram of the controller module 204 configured for template based content projection on the secondary electronic device 102, in accordance with the embodiments described herein. In an embodiment, the controller module 204 includes a detection manager 302, a secondary device context manager 304, a template manager 306, a user context manager 308, a template preview manager 310, and a projection manager 312.

In one embodiment, the content received by controller module 204 from the server 104 is unpackaged. The content may be further segregated for displaying on the primary electronic device 100 and for projecting on the secondary electronic device 102.

Further, the detection manager 302 detects whether the secondary electronic device 102 is connected to the primary electronic device 100. The primary electronic device 100 is constantly searching for presence of the secondary electronic device 102. After detecting the presence of the secondary electronic device 102, the primary electronic device 100 connects with the secondary electronic device 102. Thereafter, the secondary device context manager 304 receives the capability parameters of the secondary electronic device 102. The capability parameters of the secondary electronic device 102 may include processing power, display real-estate, or the like. The capability parameters of the secondary electronic device 102 are provided as input to the template manager 306.

Further, the user context manager 308 can be configured to determine user context. The user context is provided as an input to the template manager 306. The template manager 306 determines the one or more templates based on the user context, the user device context, and the capability parameters of the secondary electronic device 102. Further, the template preview manager 310 displays a snapshot of the template along with the content to allow the user to select the template for projecting the content on the secondary electronic device 102.

The projection manager 312 projects the content on the secondary electronic device 102 in accordance with the template selected by the user.

The FIG. 3a illustrates a limited overview of the controller module 204 but, it is to be understood that other embodiments are not limited thereto. The labels provided to each module or component is only for illustrative purpose and does not limit the scope of the invention. Further, the one or more modules can be combined or separated to perform the similar or substantially similar functionalities without departing from the scope of the invention. Furthermore, the controller module 204 may include various other modules or components interacting locally or remotely along with other hardware or software components to communicate with each other for projecting the content on the secondary electronic device 102 based on the template selected by the user.

FIG. 3b illustrates a block diagram of a content creation and packaging system 314, in accordance with the embodiments described herein. In an embodiment, the content creation and packaging system 314 enables the user to create and package the templates along with the content for one or more devices. The content creation and packaging system 314 comprises standard distributable packages from studio or publisher 316, distributable package targeted for secondary extension 318, various design types for the templates, standard outputs from the studio or publisher 320, secondary device design and packaging plug-in 322, developer studio 324, and content publisher 326.

The developer studio 324 may be at least one of Eclipse, NetBeans, visual studio, or the like. The content publisher 326 may be content publishing studios such as MS Office, Adobe, iWorks, or the like. The developer studio 324 and the content publisher 326 allow the user or a developer to create packages in a deployable manner. A plug-in added to the content creation and packaging system 314 allows the developer to create multiple templates or formats based on the context and the capability parameters of the secondary electronic device 102.

The plug-in also allows packaging of different formatted content variants along with the standard outputs from the studio or the publisher 320. The packaging created by the plug-in adheres to open standards and allows it to be opened and read in standard readers.

Further, the packaging is bucketed into two broad categories:

A) Web application based packaging in which the packaging is done as the application and displaying may be performed by a Java script that gets embedded as part of the web application.

B) PPT document, PDF document, or the like. The documents may be packaged in a compressed format and sent to an application residing on the primary electronic device 100. The application may have a capability to decompress the documents and depending upon a file format, a required application may be invoked to display the contents. As soon as the secondary electronic device 102, for projection of the content, is detected, the application which is continuously listening acquires control to display different snapshots of optimized content on the primary electronic device 100. A snapshot may be selected for projecting the optimized content on the secondary electronic device 102.

The FIG. 3b illustrates a limited overview of the content creation and packaging system 314 but, it is to be understood that other embodiments are not limited thereto. The labels provided to each module or component is only for illustrative purpose and does not limit the scope of the invention. Further, the one or more modules can be combined or separated to perform the similar or substantially similar functionalities without departing from the scope of the invention. Furthermore, the content creation and packaging system 314 may include various other modules or components interacting locally or remotely along with other hardware or software components to communicate with each other for projecting the content on the secondary electronic device 102 based on the template selected by the user.

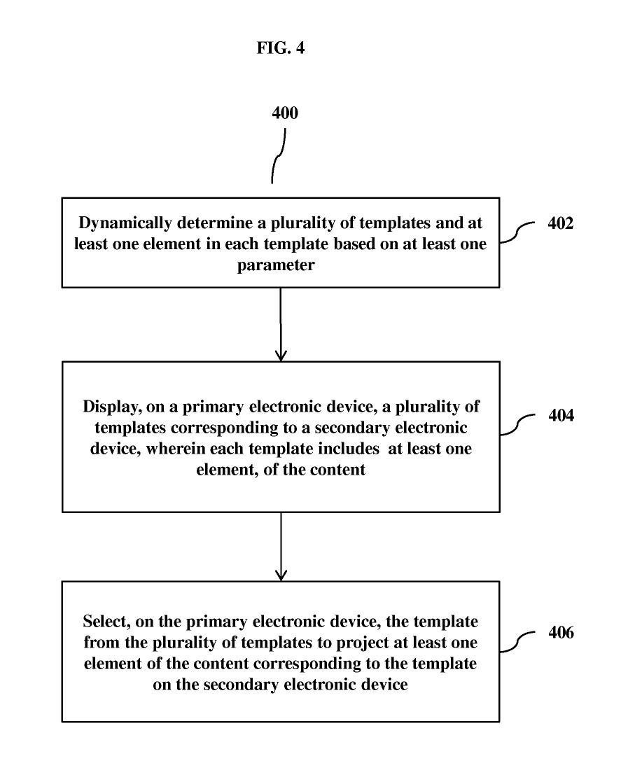

FIG. 4 is a flow diagram illustrating a method 400 for template based content projection, in accordance with the embodiments described herein. In an embodiment, at step 402, the method 400 includes dynamically determining a plurality of templates and at least one element in each template based on one or more parameters. The one or more parameters may include capability parameters of the secondary electronic device 102, user context, nature of content, time of a day, a day of a month, a month of a year, an intent of a user, primary electronic device context, and secondary electronic device context. The capability parameters of the secondary electronic device 102 may include processing power, display real-estate, or the like. In one embodiment, the method 400 allows the primary electronic device 100 to determine the plurality of templates and at least one element in each template based on at least one parameter.

At step 402, the method 400 includes displaying, on the primary electronic device 100, the plurality of templates corresponding to the secondary electronic device 102. Each template includes at least one element of the content.

At step 404, the method 400 includes selecting, on the primary electronic device 100, the template from the plurality of templates to project at least one element of the content corresponding to the template on the secondary electronic device 102. Further, the method 400 includes projecting at least one element of the content on the secondary electronic device 102. The element of the content is dynamically displayed in accordance with the selected template.

The method 400 and other description described herein provide a basis for a control program which may be easily implemented by a microcontroller, a microprocessor, or a combination thereof. The various actions, acts, blocks, steps, or the like in the method 400 may be performed in the order presented, in a different order or simultaneously. Further, in some embodiments, some of the actions, acts, blocks, steps, or the like may be omitted, added, modified, skipped, or the like without departing from scope of the invention.

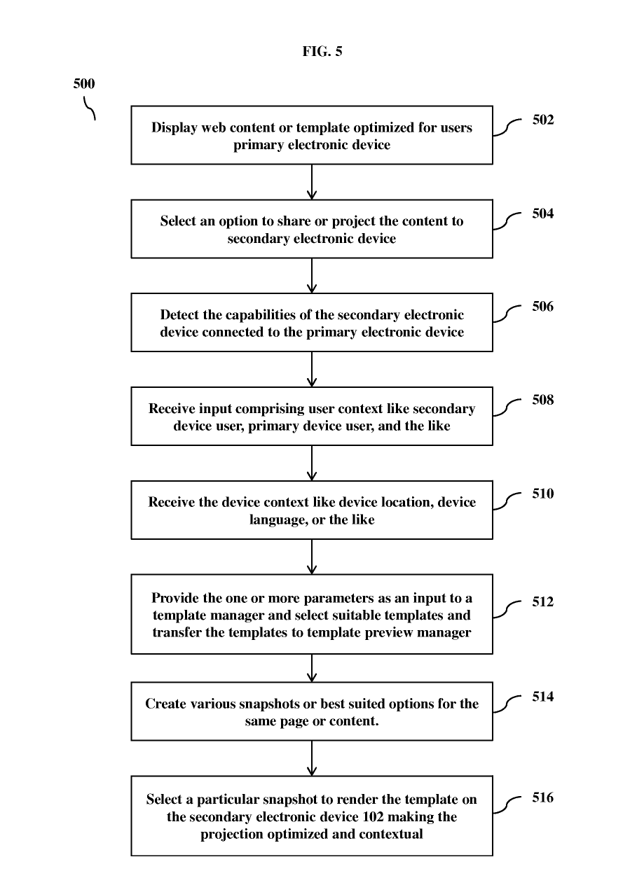

FIG. 5 is a flow diagram illustrating another method 500 for template based content projection, in accordance with the embodiments described herein. In an embodiment, at step 502, the method 500 includes displaying web content or a template optimized for displaying on the primary electronic device 100. Further, a connection between the primary electronic device 100 and the secondary electronic device 102 is detected. After detecting the connection between the primary electronic device 100 and the secondary electronic device 102, at step 504, the method 500 includes selecting an option to share or project the content on the secondary electronic device 102. The option may be selected by the primary electronic device 100 based on a user input.

Further, at step 504, the method 500 includes detecting the capability parameters of the secondary electronic device 102 connected to the primary electronic device 100. Further, at step 506, the method 500 includes receiving the user input comprising user context like secondary electronic device user context, primary electronic device user context, or the like.

At step 508, the method 500 includes receiving primary electronic device context like primary electronic device location, primary electronic device language, secondary electronic device context like secondary electronic device location, secondary electronic device language, or the like.

At step 510, the method 500 includes providing the one or more parameters as an input to the template manager 306. The method 500 further includes determining suitable templates and transferring the templates to the template preview manager 310.

At step 512, the method 500 includes creating various snapshots or best suited options for the same web page or the content. At step 514, the method 500 includes selecting a particular snapshot to render the template on the secondary electronic device 102 making the projection optimized and contextual.

The method 500 and other description described herein provide a basis for a control program which may be implemented by a microcontroller, a microprocessor, or a combination thereof. The various actions, acts, blocks, steps, or the like in the method 500 may be performed in the order presented, in a different order or simultaneously. Further, in some embodiments, some of the actions, acts, blocks, steps, or the like may be omitted, added, modified, skipped, or the like without departing from scope of the invention.

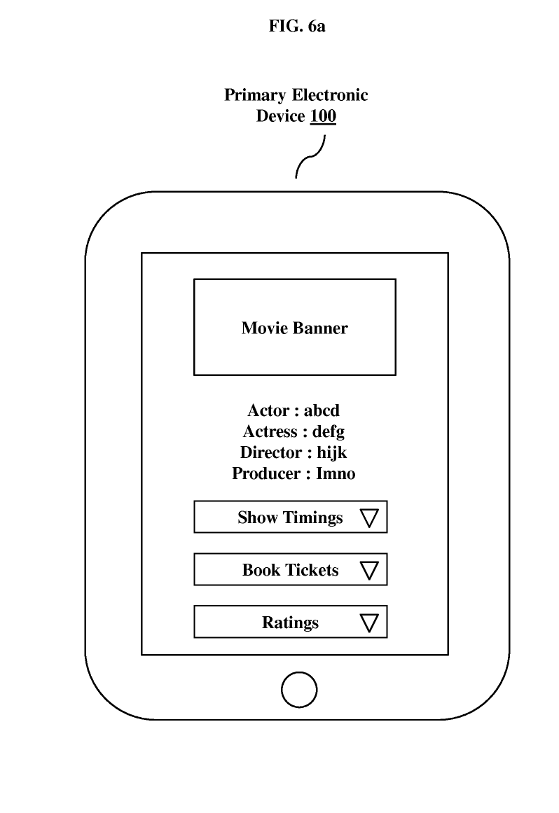

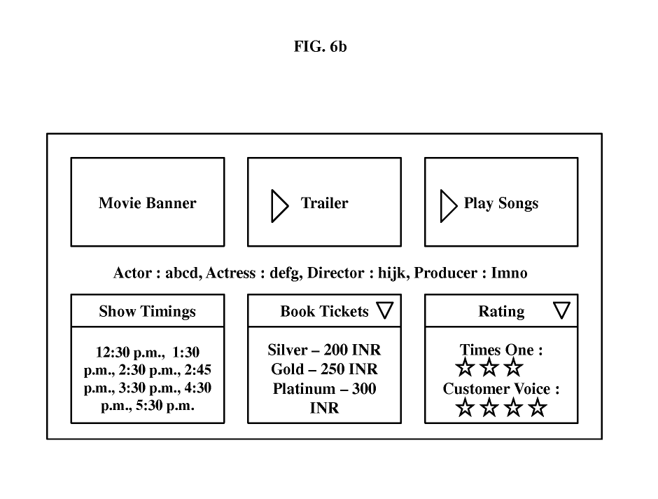

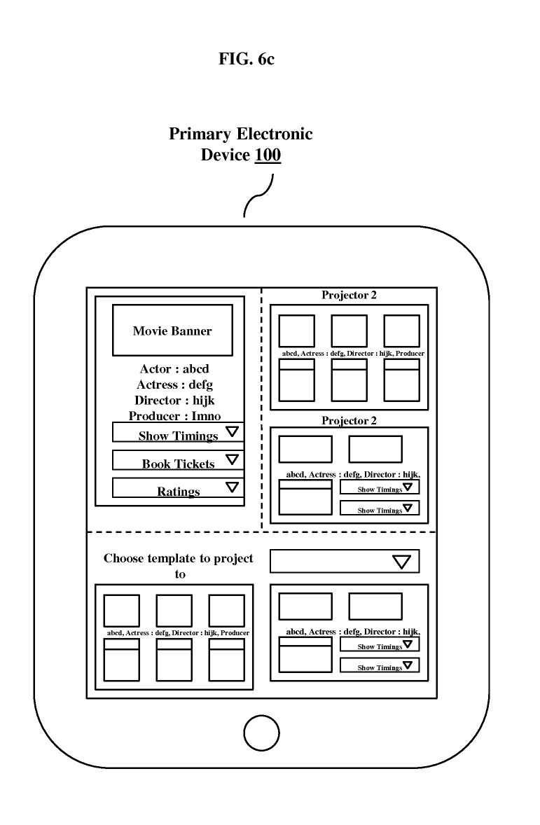

FIGS. 6a-6c illustrate example contents of a movie ticket booking page displayed on the primary electronic device 100, in accordance with the embodiments described herein. In one embodiment, consider that the primary electronic device 100 is a mobile device. Also, consider that a user performs a visual search of a movie poster using an application residing on the mobile device. After performing the visual search, web page content corresponding to the visual search may be displayed on the mobile device. The web page content displayed on the mobile device may be optimized for a mobile device display. As illustrated in the FIG. 6a, the web page displayed may comprise one snap of a movie banner, followed by cast details, show timings, or ticket rates in a hide and show fashion.

Further, the user may wish to project the web page content on another device (the secondary electronic device 102). Consider that the secondary electronic device 102 is a desktop. The content to be projected on the desktop may be a variant of the web page content. The FIG. 6b illustrates the content to be projected on the desktop. The content may comprise additional information such as trailer, songs, or the like.

Further, the mobile device may determine one or more templates comprising one or more elements for projecting the content, based on the capability parameters of the desktop, the user context, or the like. For example, the capability parameters may include screen resolution of the desktop, screen size, the processing power, or the like. The FIG. 6c illustrates the one or more templates comprising the one or more elements displayed on the mobile device. The one or more elements may be a dropdown for selection of the show timings, a dropdown for the selection of the rating, or the like.

After displaying the one or more templates on the mobile device, the mobile device allows the user to select the template for projecting the content on the desktop. After selecting the template, the content may be projected on the desktop in accordance with the template.

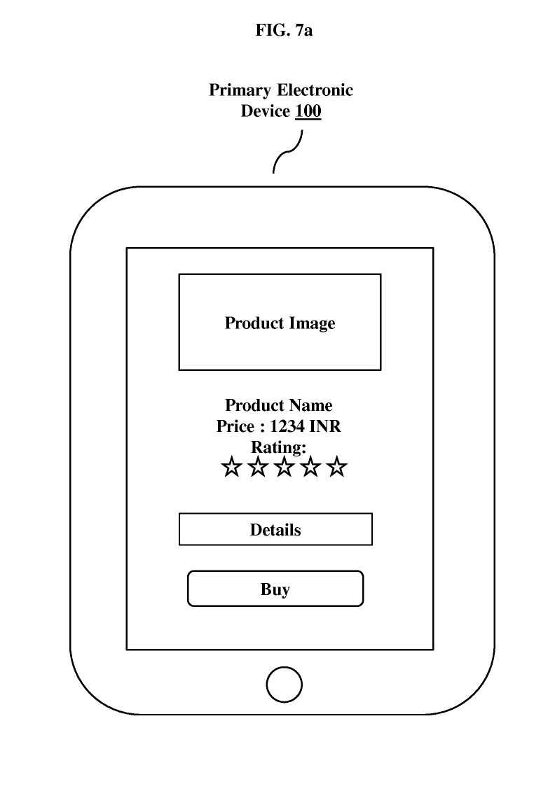

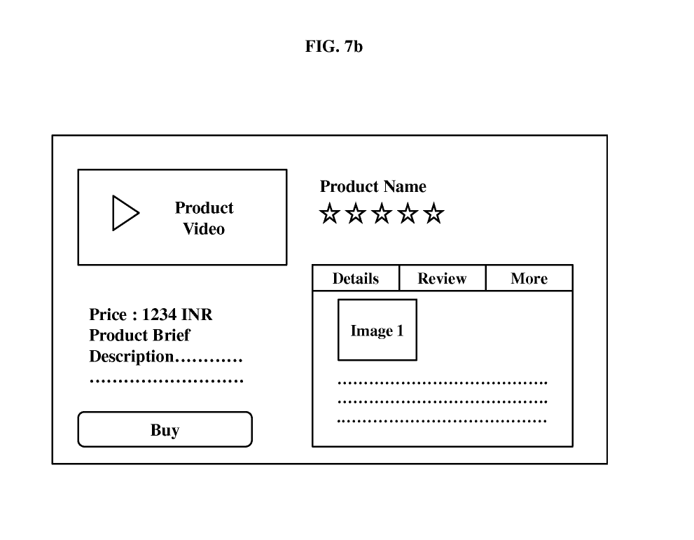

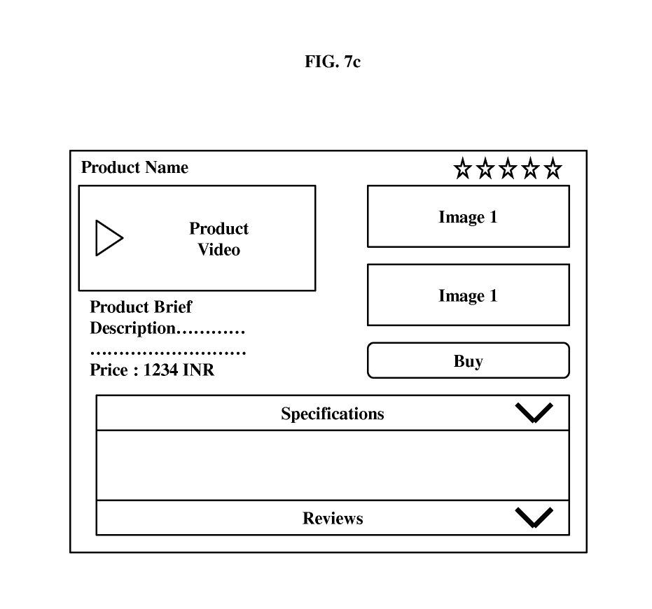

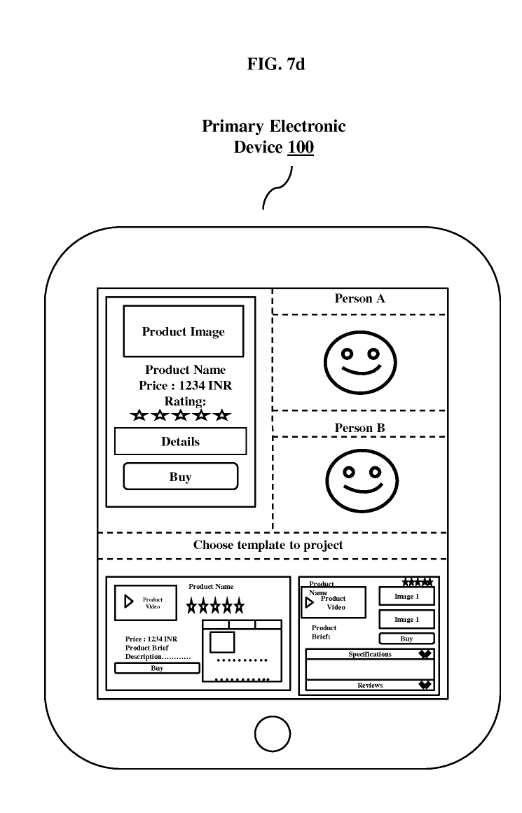

FIGS. 7a-7d illustrate example contents of a product purchase webpage displayed on the primary electronic device 100, in accordance with the embodiments described herein. In one embodiment, consider that the primary electronic device 100 is a mobile device. Also, consider that a user is browsing through an online store website, where the user chooses to view a particular product. The web page content may be rendered according to the capability parameters of the mobile device and logged in user's preferences. The web page content may comprise product description, specifications, review, and an option to buy along with an image of the product as shown in the FIG. 7a.

When the user tries to project or share product details with another person (Person-A), presenting the same page or view may not be appealing or relevant for the Person-A. Hence, the mobile device may generate a different view of the web page content for the Person-A according to parameters like gender, age, profile information, or the like, to lure the Person-A into buying the product. According to the parameters associated with the Person-A, the web page content rendered may comprise a video, product brief description, ratings, tabbed content and an option to buy. The FIG. 7b illustrates the web page content to be rendered for the Person-A.

Similarly, for another person (Person-B), the web page content rendered may vary based on the parameters corresponding to the Person-B. The FIG. 7c illustrates the web page content to be rendered for the Person-B.

When the user desires to project the web page content displayed on the mobile device with one or more connected secondary electronic devices 102, the mobile device may display one or more templates corresponding to the Person-A and Person-B. The one or more templates may be options of views which are optimized according to personal profiles of the Person-A, and the Person-B. The mobile device may allow the user to select an option.

The FIG. 7d illustrates the one or more templates comprising the one or more elements displayed on the mobile device. After selecting the template, the content may be projected on the secondary electronic device 102 in accordance with the template selected.

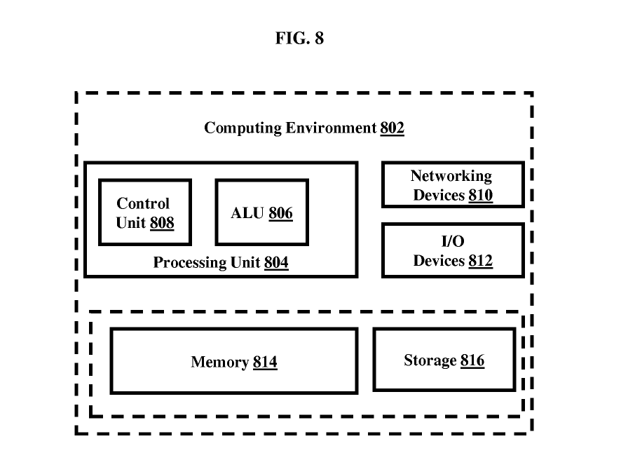

Referring to FIG. 8a, computing environment 802 implementing the method for template based content projection is illustrated. As depicted, the computing environment 802 includes at least one processing unit 804 that is equipped with a control unit 808 and an Arithmetic Logic Unit (ALU) 806, a memory 814, a storage 816, plurality of networking devices 810 and a plurality Input output (I/O) devices 812. The processing unit 804 is responsible for processing the instructions of the technique. The processing unit 804 receives commands from the control unit 808 in order to perform its processing. Further, any logical and arithmetic operations involved in the execution of the instructions are computed with the help of the ALU 806.

The overall computing environment 802 can be composed of multiple homogeneous or heterogeneous cores, multiple CPUs of different kinds, special media and other accelerators. The processing unit 804 is responsible for processing the instructions of the technique. Further, the plurality of processing units 804 can be located on a single chip or over multiple chips.

The technique comprising of instructions and codes required for the implementation are stored in either the memory 814 or the storage 816 or both. At the time of execution, the instructions can be fetched from the corresponding memory 814 or storage 816, and executed by the processing unit 804.

In case of any hardware implementations various networking devices 810 or external I/O devices 812 can be connected to the computing environment to support the implementation through the networking unit and the I/O device unit.

The embodiments disclosed herein can be implemented through at least one software program running on at least one hardware device and performing network management functions to control the elements. The FIGS. 1 to 8 include blocks which can be at least one of a hardware device or a combination of hardware device and software module.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for template based content projection, the method comprising:
displaying, on a primary electronic device, a plurality of templates corresponding to a secondary electronic device, wherein each said template comprises at least one element, of said content, dynamically determined based on at least one parameter;
selecting, on said primary electronic device, a template from said plurality of templates to project said at least one element of said content corresponding to said template on said secondary electronic device; and
projecting said at least one element of said content on said secondary electronic device in accordance with said selected template.

2. The method of claim 1, wherein said plurality of templates are dynamically determined based on said at least one parameter associated with said secondary electronic device.

3. The method of claim 1, wherein said primary electronic device is connected to said secondary electronic device.

4. The method of claim 1, wherein said at least one parameter comprises capability parameters of said secondary electronic device, user context, nature of content, time of a day, a day of a month, a month of a year, an intent of a user, primary electronic device context, and secondary electronic device context.

5. A primary electronic device for template based content projection, the primary electronic device comprising a controller module configured to:
display a plurality of templates corresponding to a secondary electronic device, wherein each said template comprises at least one element, of said content, dynamically determined based on at least one parameter;
select a template from said plurality of templates to project said at least one element of said content corresponding to said template on said secondary electronic device; and
project said at least one element of said content on said secondary electronic device in accordance with said selected template.

6. The primary electronic device of claim 5, wherein said plurality of templates are dynamically determined based on said at least one parameter associated with said secondary electronic device.

7. The primary electronic device of claim 5, wherein said primary electronic device is connected to said secondary electronic device.

8. The primary electronic device of claim 5, wherein said at least one parameter comprises capability parameters of said secondary electronic device, user context, nature of content, time of a day, a day of a month, a month of a year, an intent of a user, primary electronic device context, and secondary electronic device context.

9. A method for template based content projection, the method comprising:
receiving, by a primary electronic device, said content from a server;
displaying, on said primary electronic device, a plurality of templates corresponding to a secondary electronic device, wherein each said template comprises at least one element, of said content, dynamically determined based on at least one parameter;
selecting, on said primary electronic device, a template from said plurality of templates to project said at least one element of said content corresponding to said template on said secondary electronic device; and
projecting said at least one element of said content on said secondary electronic device in accordance to said selected template.

10. The method of claim 9, wherein said plurality of templates are dynamically determined based on said at least one parameter associated with said secondary electronic device.

11. The method of claim 9, wherein said primary electronic device is connected to said secondary electronic device.

12. The method of claim 9, wherein said at least one parameter comprises capability parameters of said secondary electronic device, user context, nature of content, time of a day, a day of a month, a month of a year, an intent of a user, primary electronic device context, and secondary electronic device context.

13. A primary electronic device for template based content projection, the primary electronic device comprising a controller module configured to:
receive said content from a server;
display a plurality of templates corresponding to a secondary electronic device, wherein each said template comprises at least one element, of said content, dynamically determined based on at least one parameter;
select a template from said plurality of templates to project said at least one element of said content corresponding to said template on said secondary electronic device; and
project said at least one element of said content on said secondary electronic device in accordance to said selected template.

14. The primary electronic device of claim 13, wherein said plurality of templates are dynamically determined based on said at least one parameter associated with said secondary electronic device.

15. The primary electronic device of claim 13, wherein said primary electronic device is connected to said secondary electronic device.

16. The primary electronic device of claim 13, wherein said at least one parameter comprises capability parameters of said secondary electronic device, user context, nature of content, time of a day, a day of a month, a month of a year, an intent of a user, primary electronic device context, and secondary device context.
